(19) United States
(12) Patent Application Publication
(10) Pub. No.: US 2016/0150878 A1
(43) Pub. Date: Jun. 2, 2016

(54) DIVIDER FOR INDUSTRIAL SHELVES

(71) Applicant: Christopher D. Clark, Parma, OH (US)

(72) Inventor: Christopher D. Clark, Parma, OH (US)

(73) Assignee: AKRO-MILS, Akron, OH (US)

(21) Appl. No.: 14/557,353

(22) Filed: Dec. 1, 2014

(51) Int. Cl. A47B 57/58; F16B 2/22

(52) U.S. Cl. CPC A47B 57/58; F16B 2/22

(57) ABSTRACT

The present invention provides a divider for industrial shelves having a planar base that lies flat on a shelf with an upwardly extending notch that accommodates the ridge formed on the front of many shelves. The downwardly extending spiral torsion spring is provided to fit over the front reinforcing wall of a shelf allows a snug but repositionable fit of the divider on a shelf. A reinforcing ridge is formed at the edges of the divider wall. Reinforcing ridges are also formed around a number of cutouts formed in the divider wall. The increased thickness of the reinforcing ridges decreases the flex in the divider wall when used to support items on a shelf. A chamfer formed at the base of the divider wall increases stiffness of the wall and inhibit cracking between the base and divider wall.

### CROSS-REFERENCE TO RELATED APPLICATIONS

The present invention is a Continuation-In-Part of U.S. Provisional Application No., entitled “DIVIDER FOR INDUSTRIAL SHELVES” and filed Sep. 27, 2014 and listing CHRISTOPHER D. CLARK as Inventor. All aspects of Application No. 61/883,729 application are hereby incorporated by reference.

### BACKGROUND

A large installed base of industrial shelf systems is in use in industrial storage. Typically the shelves are mounted wall or on a vertical framework and have fixed upwardly extending dividers. The shelving is difficult to customize for storing items of differing widths and does not providing for any width adjustable.

### SUMMARY

In accordance with embodiments of the present invention, a divider for industrial shelves is provided having a divider for industrial shelves having a planar base that lies flat on a shelf with an upwardly extending notch that accommodates the ridge formed on the front of many shelves. The downwardly extending spiral torsion spring is provided to fit over the front reinforcing wall of a shelf allows a snug but repositionable fit of the divider on a shelf. A reinforcing ridge is formed at the edges of the divider wall. Reinforcing ridges are also formed around a number of cutouts formed in the divider wall. The increased thickness of the reinforcing ridges decreases the flex in the divider wall when used to support items on a shelf. Ridges formed at the base of the divider wall increase stiffness of the wall and inhibit cracking between the base and divider wall.

### BRIEF DESCRIPTION OF THE DRAWINGS

A more complete appreciation of the invention and the many embodiments thereof will be readily obtained as the same becomes better understood by reference to the following detailed description when considered in connection with the accompanying drawings, wherein:

FIG. 1 illustrates an isometric view of an adjustable divider for industrial shelves of the present invention;

FIG. 2 illustrates side plan view of an adjustable divider for industrial shelves of the present invention.

FIG. 3A illustrates a top plan view of an adjustable divider for industrial shelves of the present invention.

FIG. 3B illustrates a bottom plan view of an adjustable divider for industrial shelves of the present invention.

FIG. 4A illustrates a front plan view of an adjustable divider for industrial shelves of the present invention.

FIG. 4B illustrates a front plan view of an adjustable divider for industrial shelves of the present invention.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

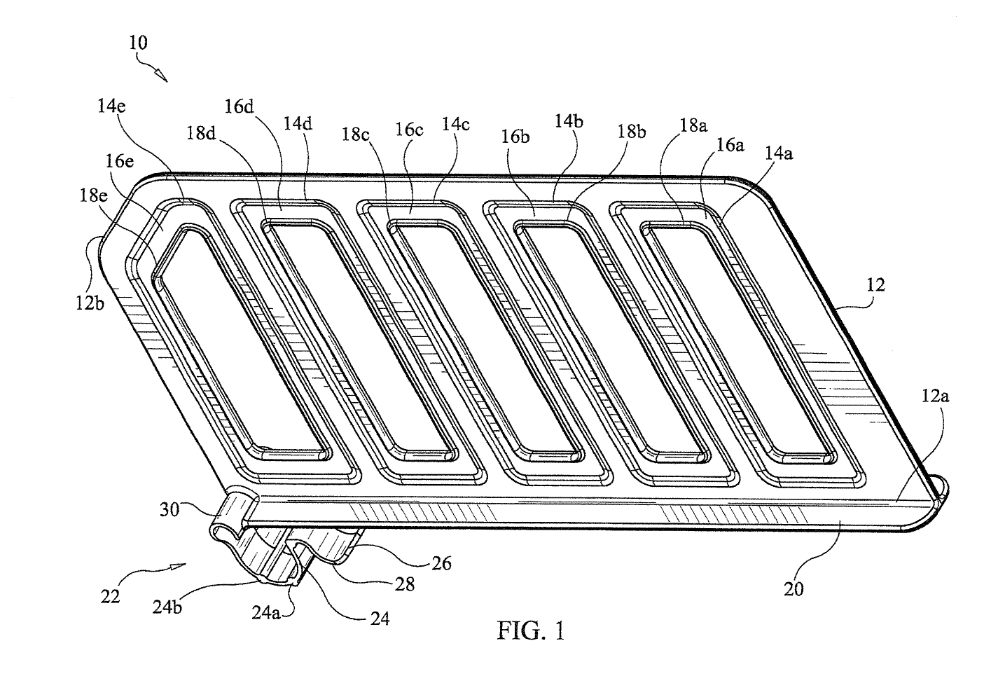

A divider 10 for industrial shelves is shown in FIG. 1. The divider 10 provides a repositionable, lightweight, and durable divider 10 that is suitable for use with a wide variety of industrial shelves. The divider 10 includes a substantially planar base 20 that lies generally flat on a shelf. Divider 10 includes is an upright divider wall 12 that is substantially perpendicular to base 20. A chamfer 12a is formed at the junction between the upright 12 and base 20. The divider 20 wall is reinforced by a ridge 12b formed at the edges of the wall and may also be reinforced by primary ridges 14a, 14b, 14c, 14d, 14e formed around a number of cutouts in the divider wall. Secondary reinforcing ridges 18a, 18b, 18c, 18d, 18e may also be formed at each cutout. Primary reinforcing ridges 14a, 14b, 14c, 14d, 14e and secondary reinforcing ridges 18a, 18b, 18c, 18d, 18e are preferably separated by a spacer walls 16a, 16b, 16c, 16d, 16e, which are generally coplanar with upright divider wall 12. At the leading edge of the divider base 20 is a notch 32 that extends upwardly into divider wall 12 to accommodate a ridge, which is formed on the front of many shelving units. Also at the leading edge of the divider base is a downwardly extending spiral torsion spring 22, which fits over the front reinforcing wall of a shelf. The spiral torsion spring typically includes front face 30, torsion section 24, shelf contact section 26 and thumb release section 28. Contact points 24a, 24b may be formed in torsion section 24 in order to reinforce the torsion section 24 and to contact the lower edges of various shelves. In use, divider 10 is placed on a shelf with shelf contact 26 against the front of the shelf. Divider is then pressed back so that the torsion spring section 24 deflects such that the shelf is retained between the shelf contact 26 and the shelf base 20, with the front edge of the shelf against front face 30 to provide a shelf allows a snug but repositionable fit of the divider on a shelf.

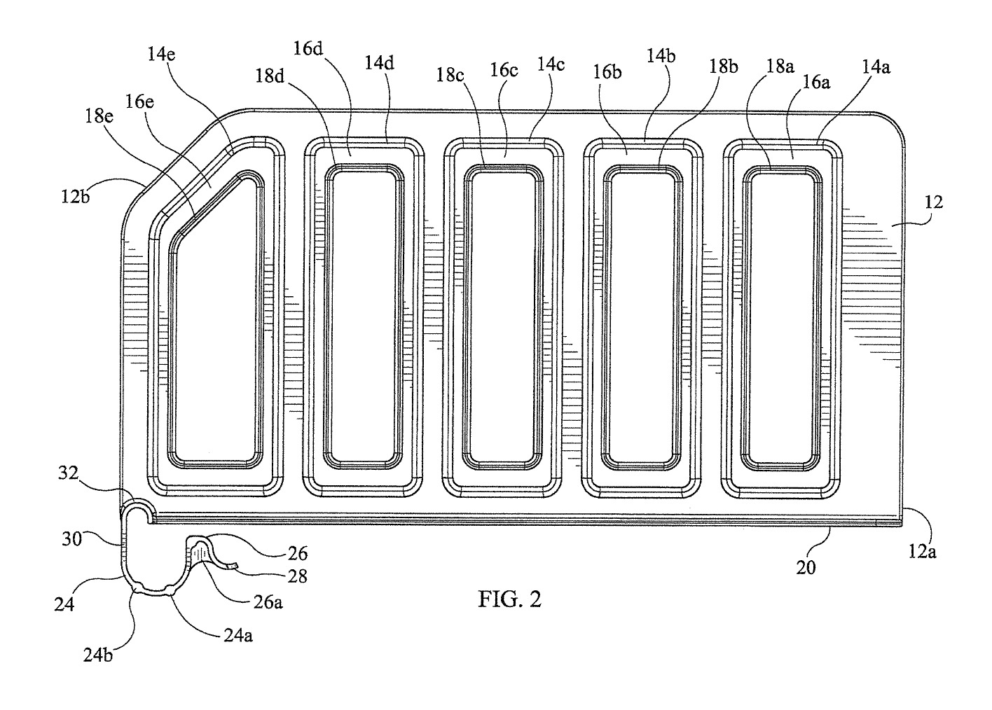

The divider 10 for industrial shelves of the present invention is shown in FIG. 2. The divider 10 includes a substantially planar base 20 that lies generally flat on a shelf. Divider 10 includes an upright divider wall 12 that is substantially perpendicular to base 20. A chamfer 12a is formed at the junction between the upright 12 and base 20 to reinforce upright 12. The divider 20 wall is reinforced by a ridge 12b formed at the edges of and generally circumventing wall 12. Wall 12 may also be reinforced by primary ridges 14a, 14b, 14c, 14d, 14e formed around a number of cutouts. Secondary reinforcing ridges 18a, 18b, 18c, 18d, 18e may be formed at each cutout. Primary reinforcing ridges 14a, 14b, 14c, 14d, 14e and secondary reinforcing ridges 18a, 18b, 18c, 18d, 18e are preferably separated by a spacer walls 16a, 16b, 16c, 16d, 16e that are generally coplanar with upright divider wall 12. At the leading edge of the divider base 20 is a notch 32 that extends upwardly into divider wall 12 to accommodate a ridge, which is formed on the front of many shelving units. Also at the leading edge of the divider base is a downwardly extending spiral torsion spring 22, which fits over the front reinforcing wall of a shelf. The spiral torsion spring typically includes front face 30, torsion section 24, shelf contact section 26, shelf contact reinforcement 26a and thumb release section 28. Reinforcements 24a, 24b may be formed in torsion section 24.

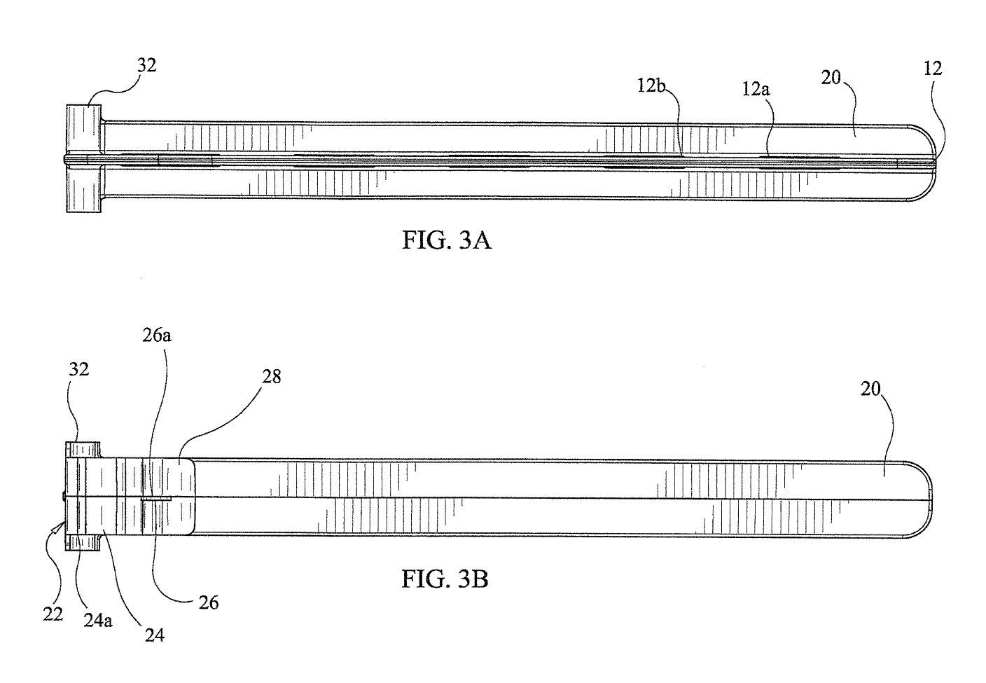

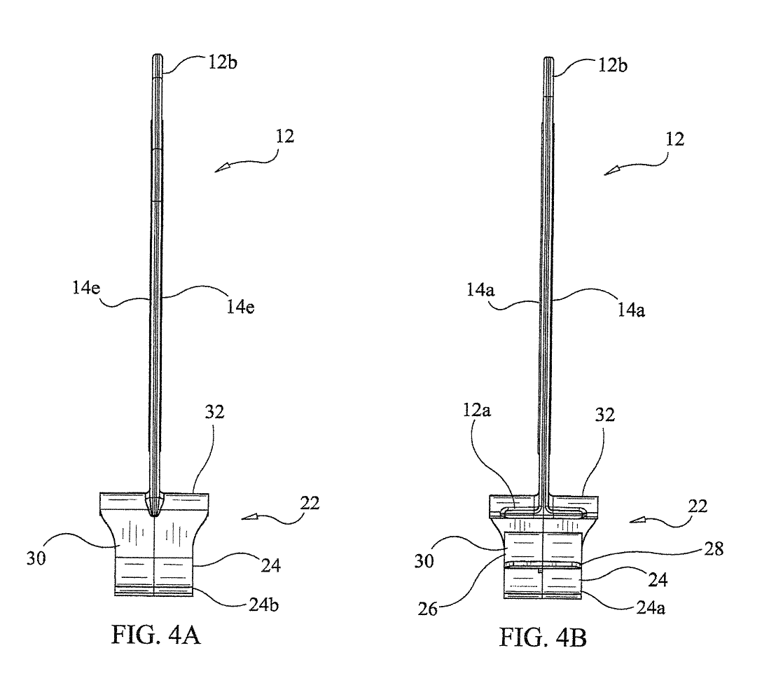

The top of the divider 10 is shown in FIG. 3A. As discussed, the planar base 20 lies flat on a shelf with an upwardly extending notch 32 formed at the front edge. A reinforcing ridge 12b surrounds the edges of upright divider wall 12. Primary reinforcing ridges 14a, 14b, 14c, 14d, 14e and secondary reinforcing ridges 18a, 18b, 18c, 18d, 18e formed around the cutouts in the divider wall are not shown. Chamfer 12a is formed between the divider wall and base.

The bottom view of divider 10 is shown in FIG. 3B. As discussed above, the planar base 20 lies flat on a shelf with downwardly extending spiral torsion spring 22 at the leading edge to fit over the front reinforcing wall of a shelf front face. Torsion spring 22 includes front face 30, torsion section 24, shelf contact section 26, shelf contact reinforcement 26a and thumb release section 28. Reinforcements 24a, 24b may be formed in torsion section 24.

The front of the divider 10 is shown in FIG. 3A. As discussed, the planar base 20 (not shown) lies flat on a shelf with an upwardly extending notch 32 formed at the front edge. A reinforcing ridge 12b surrounds the edges of upright divider wall 12. Primary reinforcing ridges 14e formed around the front cutout in the divider wall is shown. Chamfer 12a is formed between the divider wall and base. Torsion spring 22 includes front face 30, torsion section 24, shelf contact section and reinforcement 24b may be formed in torsion section 24.

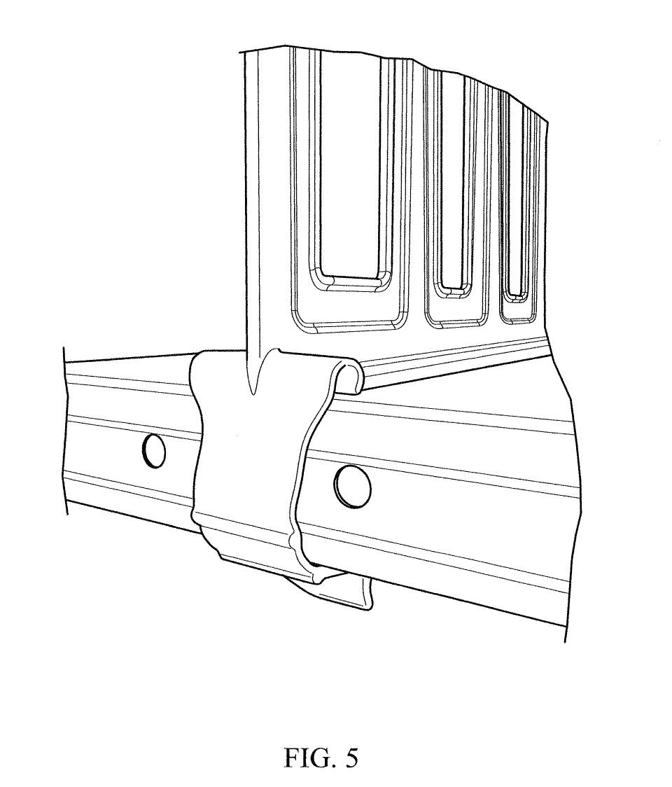

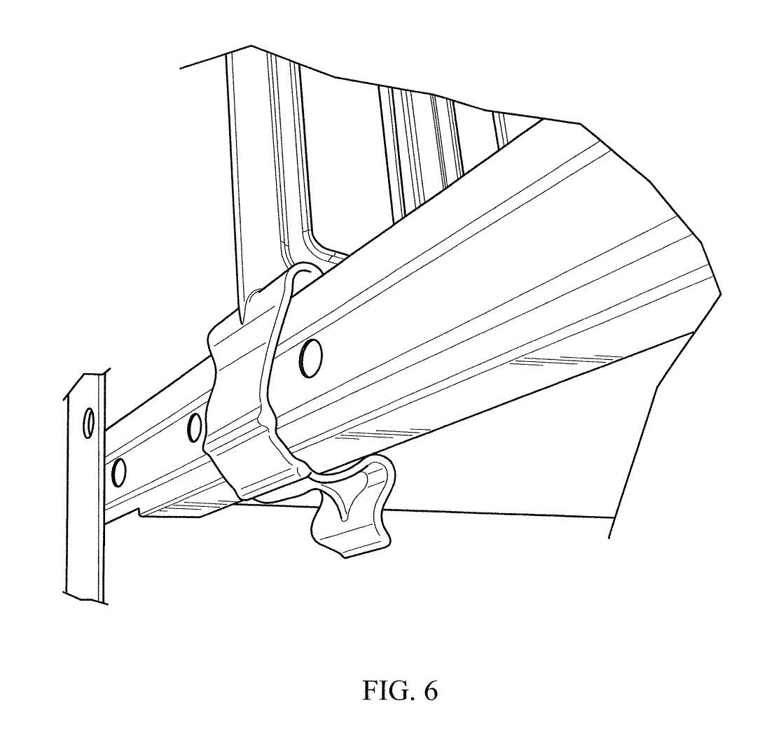

The rear view of divider 10 is shown in FIG. 4B. As discussed above, the planar base 20 lies flat on a shelf with a downwardly extending spiral torsion spring 22 at the leading edge to fit over the front reinforcing wall of a shelf front face. Torsion spring 22 includes front face 30, torsion section 24, shelf contact section 26, and thumb release section 28. Reinforcement 24a may be formed in torsion section 24.

While the shelf divider may be formed of any suitable material and by any method, typically the dividers are formed of injection molded plastic or metal. Generally the divider will be formed of by injection molding from ABS, acetyl polymers, nylon, or polystyrene (HIPS), polypropylene or polyethylene is or any other suitable polymer.

1. A divider for contacting an industrial shelf comprising:
a planar base having a upper and lower surface and a leading edge and a trailing edge;
an upwardly extending notch formed at the leading edge of the planar base;
a downwardly extending curved torsion spring formed at the leading edge of the planar base, said torsion spring including at least one reinforcing contact point, and a divider wall extending upwardly from the upper surface of the planar base, said reinforcing contact point of the spring contacting said shelf so that the shelf is retained between the planar base and the spring via a snug fit.

2. The divider of claim 1, further comprising:
a reinforcing ridge formed at the edges of the divider wall

3. The divider of claim 1, further comprising:
a plurality of cut outs formed in the divider wall.

4. The divider of claim 3, further comprising:
reinforcing ridges formed at the edges of the cut outs in the divider wall.

5. The divider of claim 3, further comprising:
a chamfer formed between divider wall and the planar base.

6. The divider of claim 3, wherein the spring is a spiral torsion spring.

7. The divider of claim 1, further comprising:
buttresses formed between divider wall and the planar base.

8. The divider of claim 1, wherein the spring is a spiral torsion spring

9. A divider for contacting an industrial shelf comprising:
a planar base having a upper and lower surface and a leading edge and a trailing edge;
an upwardly extending notch formed at the leading edge of the planar base;
a downwardly extending curved spiral torsion spring formed at the leading edge of the planar base, said torsion spring including at least one reinforcing contact point;
a divider wall extending upwardly from the upper surface of the planar base, the divider having front, top and rear edges, each edge having a reinforcing ridge formed on the circumference thereof; and
a chamfer formed between divider wall and the planar base, said reinforcing contact point of the spring contacting the shelf so that the shelf is retained between the planar base and the spring via a snug fit.

10. The divider of claim 9, further comprising:
a plurality of cut outs formed in the divider wall.

11. The divider of claim 10, further comprising:
reinforcing ridges formed at the edges of the cut outs in the divider wall.

12. The divider of claim 9, wherein the divider is formed by the process of injection molding

13. The divider of claim 9, wherein the divider is formed from a polymer selected from the group consisting of ABS, acetyl polymers, nylon, polystyrene, polypropylene, and polyethylene.
